(19) United States
(12) Patent Application Publication
(10) Pub. No.: US 2009/0006507 A1
(43) Pub. Date: Jan. 1, 2009

(54) System and method for ordering reclamation of unreachable objects

(76) Inventor: MINGNAN GUO, Burnaby (CA)

Correspondence Address: MINGNAN GUO, P.O. Box 19343, Metrotown, Burnaby, BC, V5H 4J8, CA

(21) Appl. No.: 12/143,615

(22) Filed: Jun. 20, 2008

Related U.S. Application Data
(60) Provisional application No. 60/946,393, filed on Jun. 27, 2007.

(51) Int. Cl. G06F 17/30

(52) U.S. Cl. 707/206; 707/E17.002

(57) ABSTRACT

The present invention is a method and system for ordering reclamation of unreachable objects in a garbage collection system. After unreachable objects are determined, they are given a chance to declare dependence relationships. The system then determines zero-depended objects based on these declarations and destructs zero-depended objects. After destruction, their dependence relationships are removed or ignored by the system. By repeating destructing zero-depended objects, objects are destructed in an order that meet up the requirement from dependence declarations of application program. Therefore, it guarantees safety for destructors to use/access other unreachable objects.

### CROSS REFERENCE TO RELATED APPLICATION

This application is based on and hereby claims priority to U.S. Application No. US60/946,393 filed on 27 Jun. 2007, the contents of which are hereby incorporated by reference.

### FIELD OF THE INVENTION

The present invention relates to computer programming and memory management. More specifically, the present invention relates to the garbage reclamation ordering in an automatic memory management environment.

### BACKGROUND OF THE INVENTION

Automatic memory management, also known as garbage collection (GC), is a service that automatically reclaims objects that a program would not use again. An object becomes garbage and is deemed for reclamation when the garbage collection system detects that the object is unreachable via any references (although an object may be no longer used even when it was reachable). In this article, we merely consider unreachable objects that have been determined by the GC system, and describe a novel system and method to orderly reclaim these unreachable objects and handle the related issues.

Prior to describing this invention, some related facts are reviewed here as followings:

First, an unreachable object does not mean there is no pointer referencing it. An unreachable object might belong to a group of objects, which as a whole is unreachable from application program. Within the group, there might be one or more references to the unreachable object and others. In another words, merely a reference to an object can not guarantee the object is reachable and accessible, unless the reference is coming from live area that application program can access.

Second, an object that is determined to be unreachable by the GC system does not mean the object will no longer be accessed. In fact, an unreachable object might have a destructor defined and it will be called while the system is reclaiming those unreachable objects. The destructor might access the current object, and/or other unreachable or reachable objects. Therefore, unreachable objects might be accessed by its own destructor, and/or by one or more destructors of other unreachable objects.

After a group of objects are determined to be unreachable, GC system will invoke the destructors of these objects to cleanup environments. The question is, on which order should the system invoke these destructors?

Some implementations invoke destructors with no ordering. A typical example is the finalization mechanism on the Java™ or .NET™ platform, which requires that the program code should not depend on any execution order of finalization routines. That means when a finalization routine is executing, other objects that it references might have been finalized and not in a working state. Therefore, the finalization routine cannot use/access any other objects unless there are other mechanisms from application program to ensure the referenced objects alive. This burden is especially heavy for a large-scale application program, which the object reference-relationship is so complicated and might dynamically change.

In some cases, it is even impossible to guarantee an order of reclamation solely by application program. For example, suppose object A and B reference each other and form a circular reference path; Both A and B need to run the destructor or finalization; A's destructor will access B, which must be in a working state when destructing A; B's destructor is simple and not use A. So, a correct destructing ordering is that destructing A precedes destructing B. However, on above prior-art platforms, when A is being destructed, there are two possibilities: (1) if B is also unreachable then there is possibility that B has been destructed and out of working state; or (2) if B is reachable, then A will be reachable via the reference from B, and thus A cannot be destructed. Therefore, it is hard to solve this type of problem in a non-ordering GC system.

A number of alternative finalization orderings have been proposed. One is based on statically-assigned priority. But, because finalization ordering may change dynamically at the runtime, this is more likely to invite complexity in a large scale system. Some other designs, like Guardians, require so many changes in the programming style.

Topological ordering, such as Boehm's conservative garbage collection, bases on references relationship between objects. It simply assumes that objects that is reachable from other “finalizable” objects should be preserved (“Finalizable” objects are defined as objects with finalization routine defined). It uses the same routine of tracing garbage collector to track down references among unreachable objects. For example, if object A is referenced by unreachable object B with finalization routine defined, then the object B is remarked as alive and in-turn cause A to be reachable, so only B's finalization is called. A is preserved until the next GC cycle.

In topological ordering solution, if two “finalizable” objects just reference each other but their “finalizer” routine does not access each other, the system will not finalize these objects and will preserve them forever. In summary, topological relationship is not always reflecting the relationship of finalization ordering. In most cases, topological is too strict than actual need.

Thus, better and faster techniques are needed for reclaiming objects with ordering in an automatic memory management system.

### SUMMARY OF THE INVENTION

In view of the above limitations, a goal of the present invention is to provide a mechanism that, unreachable objects can be reclaimed in a correct ordering controlled by application program. Application program describes the requirements for the destructors of unreachable objects, and then let the system figure out a order of reclamation that fulfills the requirements.

The goal stated above is achieved by the present invention in the following manner: after unreachable objects are determined by the garbage collection, each unreachable object is given a chance to declare its dependence. These declarations make up a graph of dependence relationship. The system finds out those zero-depended objects and executes the destructors of them. The term “zero-depended object” means that there are no other objects depending on it. After an object is destructed, its dependence requirements are discarded by the system. Therefore, along with the proceeding of destruction, more other objects will become zero-depended and to be destructed.

One embodiment of the present invention maintains a count for each object. The count reflects the number of dependences on the object. If the count becomes zero, then the object is treated as zero-depended, and is eligible for object destruction.

Another embodiment determines reclamation ordering by scanning dependence declaration records and marking those objects being depended. Those unmarked objects are treated as zero-depended and eligible for destructing.

System does not change any content of unreachable objects while determining the reclamation ordering. Objects are retained in working state until destruction begins. Therefore, objects can be used/accessed by other destructing objects.

One aspect of the present invention is that the dependence relationship is independent of the reference relationship (although sometimes they can be the same). An object may reference one another but does not depend on it. Vice versa, an object may depend on another but does not have any direct reference to it.

Once an object is destructed, it means the object no longer refers to or depends on any other objects. All the influences of the destructed object upon others should be removed. For example, all contributions to other objects' dependence counts from a destructed object are removed.

Based on the dependence relationship, the system can achieve a reclamation ordering by reclaiming zero-depended objects repeatedly until no more zero-depended objects available. This ordering guarantees that, the dependee is not destructed until the depender has been completely destructed. Therefore, if an object declares a set of objects that it depends on, then the system will guarantee these objects will not be destructed prior to the destruction of the object.

A system of the present invention can be very efficient. All unreachable objects can be reclaimed in one garbage collection cycle. The system can resolve a reclamation ordering very quickly. A wide array of computer programming areas can benefit from it.

A more complete understanding of the present invention, as well as features and advantages of the present invention, will be obtained with reference to the following detailed description and drawings.

### BRIEF DESCIPTION OF THE DRAWINGS

FIG. 1 is a block diagram of a platform supporting the embodiments of the present invention;

FIG. 2 is a flowchart describing the procedure of reclaiming unreachable objects;

FIG. 3 is a flowchart of embodiment 1 using reference counting technique;

FIG. 4 is a flowchart of embodiment 2 using scanning of dependence declaration records.

### DETAILED DESCRIPTION OF PREFERRED EMBODIMENTS

Following are some conventions and terms used in this specification.

The term “unreachable object/garbage” means there is no reference path to the object from application program;

The term “destructing” means executing the destructor of an unreachable object;

The term “reclaiming object” is interchangeable with destructing object in most indulgent cases;

In the following description, for the purposes of explanation, numerous specific details are set forth in order to provide a thorough understanding of the present invention. It is apparent, however, to one skilled in the art that the present invention may be practiced without these specific details or with an equivalent arrangement.

FIG. 1 is a block diagram of computer system, which supports some embodiments of the present invention. Referring to FIG. 1 there is a computer system, which can be personal computer, personal digital assistant, smart phone, center server or other computation device. As a typical sample, the computer system 100 comprises a main processing unit 101 and power unit 102. The main processing unit 101 comprises one or more processors 103, and is connected to one or more memory storage unit 105 through system circuit 104. One or more interface devices 106 are connected to processors 103 through system circuit 104. In the present example, system circuit 104 is an address/data bus. A person skilled in the art can use other ways to connect those elements, such as using one or more dedicated data lines, or a switcher to connect processors 103 and memory storage unit 105.

Processors 103 include any processors, such as those in the Intel Pentium™ family, or Intel Itanium™ family. Memory storage unit 105 includes random access memory, such as DRAM. In this example, the memory storage unit 105 stores codes and data for execution by processor 103. Interface circuit 106 can use any standard interface, such as USB, PCI, PCMCIA, etc. One or more input devices 107 including keyboard, mouse, touch pad, voice recognition device, etc, are connected to main process unit 101 through one or more interface circuit 106. One or more output devices 108 including monitor, printer, speaker, etc, are connected to main process unit 101 through one or more interface circuit 106. The platform system can also include one or more external storage units 109, including a hard disk, CD/DVD, etc. The system connects to and exchanges data with other external computer devices through network device 110, which includes Ethernet, DSL, dial-up, wireless network, etc.

The present invention can be used to reclaim unreachable objects that are detected by garbage collection system, or it can be build as a module collaborating with other parts in the system. The garbage collection system can run in user-mode as application program, or run in kernel-mode of an operating system, or run as a part of platforms between application and kernel, such Java and .NET virtual machines, or can be a part of other systems that need automatic memory management.

Garbage collection system can detect unreachable objects by various ways, such as by reference counting, by tracing collection techniques, or a hybrid combination of these two. After one or more objects are determined as unreachable, i.e., there is no reference path to access them, they are reclaimed in an order at which the present invention aims, and is described in following sections.

We noticed the fact that, in most cases, when an object is unreachable and eligible for reclamation, it will use fewer amounts of other objects than it did when it was alive and reachable. This is because, when a set of objects are determined as unreachable, they are dying and generally their last task is to cleanup the influence of their existence, such as release resources they used, inform others they will die. These tasks normally are much simpler and require less other objects to cooperate, comparing to the tasks of a live object.

The procedure of reclaiming objects in the present invention is described below.

After garbage collection system determines a set of objects that is unreachable, the system gives these unreachable objects a chance to declare dependence relationship. For example, the system iterates all unreachable objects, and invokes a user-defined method of each object of them to declare dependence relationships. For easier understanding, we name the user-defined method as “OnReclaim”. In the OnReclaim method, the application code can callback this system to declare one or more dependence relationships. A dependence relationship involves a pair of objects, a depender and a dependee. Say, a dependence relationship “object A depends on object B”, which means object A is the depender and object B is the dependee. The task of destructing object A requires existence of object B; i.e. the destructor of A may access object B. The object B should not be destructed until the completion of destructing object A. That is, object A should be destructed prior to object B being destructed.

Generally, if object A is reachable and live, it needs not assert a dependence declaration. Any objects that object A (a live object) can access via references should always retain alive by garbage collection system as they are accessible and reachable. There is no need to declare a dependence relationship. When the system is reclaiming unreachable objects, references between objects cannot guarantee the referent alive as we explained before. So, unreachable objects should declare one or more dependence relationships to ensure the aliveness of objects it needs. If the application program knows some objects are sure to be alive, then it can skip the dependences declaration for these objects.

Generally, application program declares dependees for the current object; it can also declare a dependence of a pair from other objects. There are no constraints that depender or dependee must be current. Multiple dependences may form a dependence chain. If an object depends on the top object of a chain, then it needs not to declare dependence of lower objects in the chain. For example, object X depends on Y, and Y depends on Z, then object X can just declare dependence on object Y instead declare dependences on both Y and Z.

When all unreachable objects have declared their dependence requirements, the system can determine the reclamation ordering based on these declarations. Zero-depended objects are to be destructed first. Any destruction ordering is allowed among zero-depended objects. These zero-depended objects may reference or depend on other objects. Once an object is destructed, all its references and dependences relationship are removed. Therefore, destructing objects may lead to more objects become zero-depended.

It can be easy proved that in a non-circular dependence relationship, all objects will be destructed if the system keeps destructing zero-depended objects. Anytime, we can choose an arbitrary object, then find an object depends on it, repeats this step, we can eventually find a zero-depended object because the number of objects is finite and there is no circular dependence. So there is at least one zero-depended object can be destructed for such non-circular dependence relationship of finite objects.

By the mechanism described above, the system will guarantee that the destruction ordering will fulfill the requirement of all objects' dependence declarations. Dependees are retained in working state (not destructed) until all its dependers are destructed.

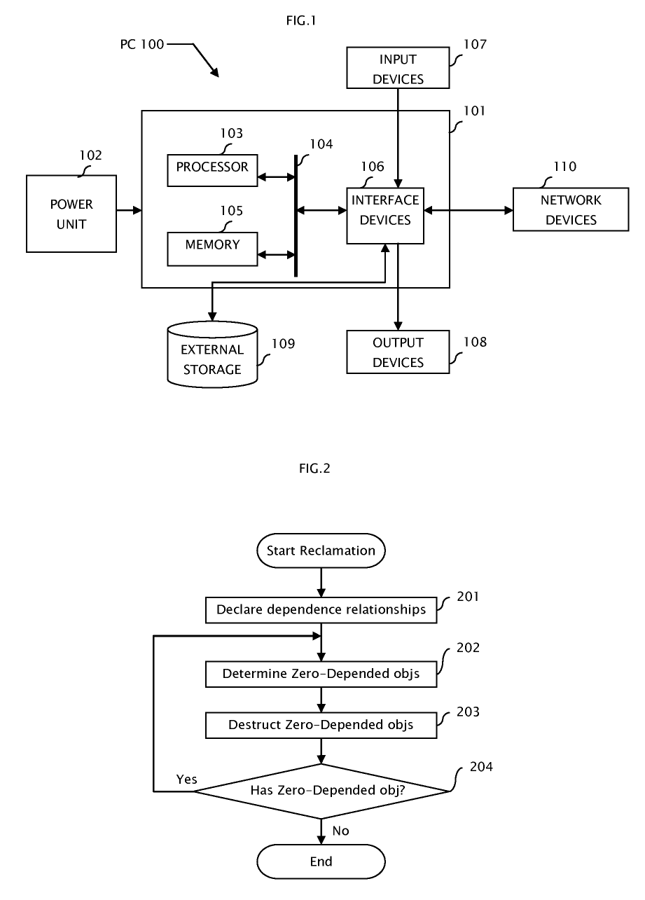

FIG. 2 is a flowchart describing the procedure of reclaiming unreachable objects. At the very beginning, the garbage collection has determined a set of objects that is unreachable. In step 201, the system iterates these unreachable objects, invoking their “OnReclaim” methods to allow application program to declare dependence relationships. In step 202, the system determines zero-depended objects from the dependence relationships. In step 203, the system executes the destructors of these zero-depended objects. During the destruction, more objects may become zero-depended. The system repeats destructing zero-depended objects in the above steps, until there is no more zero-depended object in step 204. Then, it ends the reclamation process. All unreachable objects are reclaimed in a order that meet up the dependence requirements of application program.

### Embodiment 1

Embodiment 1 of the present invention uses reference counting technique to determine zero-depended objects. Each object has a dependence count (D-count) of the number of dependences on the object. The D-count is initialized to zero. When a dependence relationship is declared by application program, the dependee's D-count is incremented. When a depender is destructed, every objects it depends have their D-counts decremented. An object with zero value of D-count means the object is zero-depended and ready for destruction.

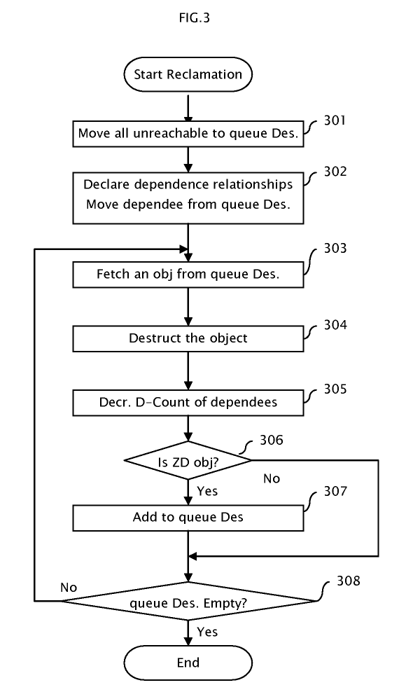

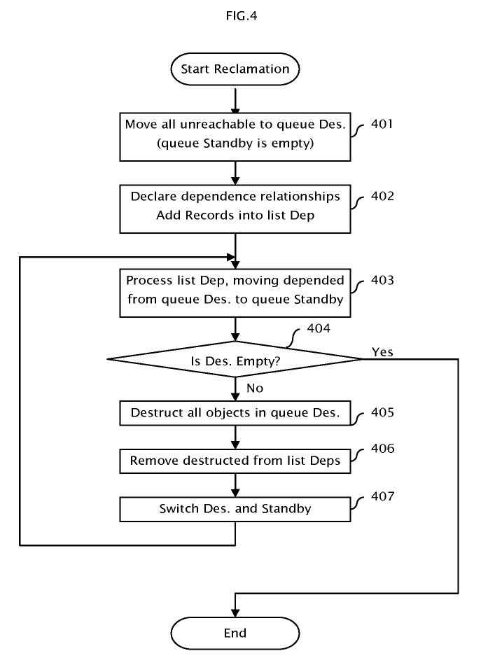

FIG. 3 is a flowchart of embodiment 1 using reference counting technique.

In step 301, all unreachable objects determined by garbage collection system are moved to a queue named “Destructing”.

In step 302, the system iterates these unreachable objects, invoking their “OnReclaim” methods to allow application program to declare dependence relationships. For each dependence declaration, the system removes the dependee from the queue “Destructing”, and increments the value of dependee's D-count. After all dependence declarations are processed, the system goes to step 303.

As objects being depended are removed from queue “Destructing” in step 302, when the flow reaches step 303, objects remaining in the queue “Destructing” are zero-depended and eligible for destructing. In step 303, the system fetches an object from queue “Destructing” for destructing.

In step 304, the system executes the destructor of the object that was fetched from the queue “Destructing”.

In step 305, after the execution of an object destructor in step 304, the system decrements the D-counts of objects on which the object is depending. The system maintains a list of dependees of each object. When the object is destructed, all dependee's D-counts are decremented (an alternative approach is to let the application program decrement the D-counts in their destructor routines).

In step 306, the system check the D-counts of objects, if they become zero, then they are inserted into queue “Destructing” in step 307.

In step 308, the system loop to step 303 until the queue “Destructing” is empty, which means there is no more zero-depended object. Thus, it ends the reclamation process as all objects are destructed in a correct order.

Note, if an object has not destructor defined, then the object can be treated as it has an empty destructor routine or just be skipped by the system.

### Embodiment 2

Embodiment 2 of the present invention uses scanning of dependence relationship records to determine zero-depended objects. The system maintains a list of Dependences records. When a dependence relationship is declared by application program, the system adds a record into the list. A dependence record contains info that points out the dependee and depender of the declared dependence relationship. When the system needs to determine zero-depended objects, it scans the dependence list. For every record in the list, it marks the dependee object as being depended if the depender has not been destructed. When the all records in dependence list are processed, the remaining unmarked objects are zero-depended and eligible for reclamation.

FIG. 4 is a flowchart of embodiment 2.

In step 401, all unreachable objects determined by garbage collection system are moved to a queue “Destructing”. Another queue “Standby” is initialized to empty.

In step 402, the system iterates these unreachable objects, invoking their “OnReclaim” methods to allow application program declare a dependence relationship. For every dependence declaration, the system adds a record describing the dependence relationship into a list “Dependence”. After all dependence declarations are processed, the system goes to step 403.

In step 403, the system scans the “Dependence” list and processes all records in it. For each record, the dependee object is directly marked as depended object, or virtually marked as moving the dependee object from queue “Destructing” to queue “Standby”. When all records in the Dependence list have been processed, the queue “Destructing” contains zero-depended objects, and queue “Standby” contains depended objects.

In step 404, the system checks the queue “Destructing”. If the queue is empty, then it means the end of the reclamation process. If not, then continues to step 405.

In step 405, the system executes the destructor of objects in the queue “Destructing” and removes them from queue “Destructing”. When finished, the queue “Destructing” becomes empty.

In step 406, the system adjusts the “Dependence” list to reflect that facts that some dependers of these records has been destructed. Records that depender has been destructed are removed from the “Dependence” list.

In step 407, the system switches queue “Destructing” and queue “Standby”, and then goes to step 403.

It is to be understood that the preferred embodiments and variations shown and described herein are merely illustrative of the principles of this invention and that various modifications may be implemented by those skilled in the art without departing from the scope and spirit of the invention.

What is claimed is:

1. A method of reclaiming unreachable objects in a garbage collection system, said method comprising:
giving a chance for unreachable objects to declare dependence relationship; destructing objects that are not depended by others;
repeating destructing objects that no object is depending on them.

2. A method as claimed in claim 1 further comprising:
maintaining a dependence count (D-count) for every object of the number of dependences on the object;
incrementing the D-count of dependee of every dependence relationship declaration;
decrementing the D-count if the depender is being destructed or have been destructed; destructing objects if their D-count are zero.

3. A method as claimed in claim 1 further comprising:
maintaining a list of records describing the dependence declaration;
scanning records of the list to determine zero-depended objects that are not the dependee in any of these records;
removing/skipping records from the list if the dependers of the records have been destructed.

4. An system that is a part of garbage collection system, the system comprising:
a module that calls application program procedures for every unreachable object to declare dependence relationship;
a module that destructs objects that is not depended by other objects;
a module that repeat destructing objects that no object is depending on them.

5. An system as claimed in claim 4 further comprising:
a module that maintains a dependence count (D-count) for every object of the number of dependence on the object; it increments the D-count of dependee of every dependence relationship declaration; it decrements the D-count if the depender is being destructed or have been destructed; it destructs objects if their D-counts are zero.

6. A method as claimed in claim 4 further comprising:
a module that maintains a list of records describing the dependence declaration; it scans these records to determine zero-depended objects that are not the dependee in any of these records; it removes or skips records from the list if the dependers of the records have been destructed.
